(19) United States
(12) Patent Application Publication
(10) Pub. No.: US 2010/0277067 A1
(43) Pub. Date: Nov. 4, 2010

(54) DIMMABLE LED LUMINAIRE

(75) Inventors: Fredric S. Maxik, Indialantic, FL (US); David Henderson, Indialantic, FL (US); Addy S. Widjaja, Palm Bay, FL (US)

Correspondence Address: CANTOR COLBURN, LLP, 20 Church Street, 22nd Floor, Hartford, CT, 06103, US

(73) Assignee: LIGHTING SCIENCE GROUP CORPORATION, Satellite Beach, FL (US)

(21) Appl. No.: 12/770,136

(22) Filed: Apr. 29, 2010

Related U.S. Application Data
(60) Provisional application No. 61/174,268, filed on Apr. 30, 2009.

(51) Int. Cl. H01K 1/62

(52) U.S. Cl. 315/32

(57) ABSTRACT

A luminaire includes an Edison type electrical base, an optic, and a heat sink disposed between the base and the optic. An LED driver circuit is disposed at least partially within the heat sink, and is disposed in electrical communication with the base. An LED assembly is disposed in thermal communication with a surface of the heat sink, and in electrical communication with the driver circuit, the LED assembly includes an LED. The driver circuit includes circuitry that converts an AC signal at the base to a DC signal and provides the DC signal to the LED assembly, the circuitry includes holding current circuitry that produces a holding current for an electrical dimmer disposed upstream of the base in response to a current to the LED assembly being reduced for light dimming purposes.

### CROSS REFERENCE TO RELATED APPLICATIONS

This application claims the benefit of U.S. Provisional Application Ser. No. 61/174,268, filed Apr. 30, 2009, which is incorporated herein by reference in its entirety.

### BACKGROUND OF THE INVENTION

The subject matter disclosed herein relates generally to a luminaire having an LED light source, particularly to an LED luminaire sized to replace an incandescent light bulb, and more particularly to an LED luminaire sized to replace an A19 incandescent light bulb.

In recent years, there has been an increased interest in luminaires, sometimes referred to as “light bulbs” or lamps, which use light emitting diodes (“LEDs”) as a light source. These luminaires are quite attractive since they overcome many of the disadvantages of the conventional light sources, which include incandescent light bulbs, fluorescent light bulbs, halogen light bulbs and metal halide light bulbs.

Conventional light sources, such as incandescent light bulbs for example, typically have a short useful life. As such, lighting systems commonly incorporate a fixture or “socket” that allows the light bulbs to be interchanged when the light bulb fails to operate. One type of socket, sometimes known as the E25 or E26 Edison base, meets the criteria set by the American National Standards Institute (ANSI), such as the ANSI C78.20-2003 standard for 60 Watt A19 type bulbs. The wide adoption of this standard allows the interchangeability of light bulbs from a variety of manufacturers into lighting systems.

Luminaires have been proposed that allow the use of LED luminaires in lighting systems. However, LED luminaires need a power conversion source, similar to a fluorescent lighting system for example, to operate. Typically, these power sources generate an undesirable amount of heat. To alleviate this issue, some proposed designs have separated the power source from the light source. This allows the power source to be positioned in an area where there is adequate cooling. While this arrangement solves the issue, it hinders the installation of the LED luminaires into existing lighting systems.

Other proposed LED luminaires have incorporated the power source into a luminaire in combination with a standard E25, E26 or E27 Edison socket. This allows the luminaire to be a direct replacement for traditional light bulbs, such as those defined by ANSI C78.20-2003 for example. However, these LED luminaires are typically used at lower luminosity ratings with a maximum lumen output equivalent to a 40-watt incandescent light bulb. The lower ratings were driven by the inability of the luminaire to adequately dissipate heat generated by the LEDs and the power supply.

Accordingly, while existing LED luminaires are suitable for their intended purposes, improvements may be made in increasing the ability of the luminaire to dissipate heat, increasing the lumen output performance, and providing for a dimmable LED luminaire, while also providing a direct replacement for conventional incandescent bulbs.

This background information is provided to reveal information believed by the applicant to be of possible relevance to the present invention. No admission is necessarily intended, nor should be construed, that any of the preceding information constitutes prior art against the present invention.

### BRIEF DESCRIPTION OF THE INVENTION

An embodiment of the invention includes a luminaire having an Edison type electrical base, an optic, and a heat sink disposed between the base and the optic. An LED driver circuit is disposed at least partially within the heat sink, and is disposed in electrical communication with the base. An LED assembly is disposed in thermal communication with a surface of the heat sink, and in electrical communication with the driver circuit, the LED assembly includes an LED. The driver circuit includes circuitry that converts an AC signal at the base to a DC signal and provides the DC signal to the LED assembly, the circuitry includes holding current circuitry that produces a holding current for an electrical dimmer disposed upstream of the base in response to a current to the LED assembly being reduced for light dimming purposes.

An embodiment of the invention includes a luminaire having an Edison type electrical base, an optic, and a heat sink disposed between the base and the optic, wherein the base, the optic, and the heat sink, collectively have a profile so configured and dimensioned as to be interchangeable with at least one of a standard A19 light bulb, a standard G25 light bulb, a standard R20 light bulb, a standard R30 light bulb, and a standard R38 light bulb. An LED driver circuit is disposed in electrical communication with the base. An LED assembly is disposed in thermal communication with a surface of the heat sink, and in electrical communication with the driver circuit. The LED assembly includes an LED. The driver circuit includes circuitry that converts an AC signal at the base to a DC signal and provides the DC signal to the LED assembly. The LED driver circuit and the LED assembly are so configured and dimensioned as to be disposed completely within the respective A19, G25, R20, R30 or R38 profile.

An embodiment of the invention includes a luminaire having a base, a power supply, a middle member, and a frosted bulb. The base includes an electrical connector thereon, wherein the electrical connector is sized and shaped to be received in an Edison medium socket. The power supply is arranged within the base, the power supply being electrically coupled to the electrical connector. The middle member is coupled to the base, the middle member including: a shell member having a hollow inner portion and a first surface on one end, wherein a first wall is arranged adjacent the base; a cup member disposed within the hollow inner portion, the cup member having a second wall arranged opposite said first wall; a heat sink disposed about the cup member within the shell member, the heat sink having a third wall adjacent the second wall, the heat sink further having a plurality of arms extending from the third wall towards the first surface, each of the plurality of arms having a substantially radial fin extending therefrom; a pad member disposed on the third surface; and, a light emitting diode (LED) board disposed on the pad member and electrically coupled to the power supply, the LED board having a plurality of LED members thereon, the plurality of LED members being made from a 1/10 millimeter die and having a height equal to or less than 1.4 millimeters. The frosted bulb is coupled to the middle member and has a substantially hollow inner portion, wherein the plurality of LED members are arranged within the bulb hollow inner portion.

An embodiment of the invention includes a luminaire having a base, a power supply, a heat sink, a pad member, a light emitting diode (LED) board, and a frosted bulb. The base includes an electrical connector thereon, wherein the electrical connector is sized and shaped to be received in an Edison medium socket. The power supply is arranged within the base, the power supply being electrically coupled to the electrical connector. The heat sink is coupled to the base and has a first end, an opposing second end and a tapered outer surface therebetween, the second end having a first recess with a conical surface therein and a center projection having a second recess, the heat sink having a plurality of openings arranged in the first recess, the plurality of openings extending towards the first end, wherein the plurality of openings have a second end that intersects the first end and the tapered outer surface. The pad member is disposed in the second recess. The LED board is disposed on the pad member and is electrically coupled to the power supply, the LED board having a plurality of LED members thereon, the plurality of LED members being made from a 1/10 millimeter die and having a height equal to or less than 1.4 millimeters. The frosted bulb is coupled to the heat sink and has a substantially hollow inner portion, wherein the plurality of LED members are arranged within the bulb hollow inner portion.

### BRIEF DESCRIPTION OF THE DRAWINGS

Referring to the exemplary drawings wherein like elements are numbered alike in the accompanying Figures:

FIG. 1 is a perspective view illustration of a luminaire in accordance with an embodiment of the invention;

FIG. 2 is side plan view illustration of the luminaire of FIG. 1;

FIG. 3 is a side sectional view illustration of the luminaire of FIG. 1;

FIG. 4 is an exploded assembly view illustration of the luminaire of FIG. 1;

FIG. 5 is an exploded assembly view illustration of a base member for use with the luminaire of FIG. 1;

FIG. 6 is an exploded assembly view illustration of an embodiment of a heat sink member for use with the luminaire of FIG. 1;

FIG. 7 is a side plan view illustration of a fin portion for the heat sink member of FIG. 6;

FIG. 8 is a top plan view illustration of the fin portion of FIG. 7;

FIG. 9 is a top perspective view illustration of the fin portion of FIG. 7;

FIG. 10 is a bottom perspective view illustration of the fin portion of FIG. 7;

FIG. 11 is a top perspective view illustration of an alternative embodiment heat sink member for use with the luminaire of FIG. 1;

FIG. 12 is a top plan view illustration of the heat sink member of FIG. 11;

FIG. 13 is a bottom plan view illustration of the heat sink member of FIG. 11;

FIG. 14 is a side sectional view of the heat sink member of FIG. 11;

FIG. 15 is a top plan view illustration of a flat surface emitter LED for the luminaire of FIG. 1;

FIG. 16 is a side plan view illustration of the flat surface emitter LED of FIG. 15;

FIG. 17 is a schematic block diagram of a lighting system in accordance with an embodiment of the invention;

FIG. 18 is a perspective view illustration of an alternative luminaire to that of FIG. 1 in accordance with an embodiment of the invention;

FIG. 19 is an exploded assembly view illustration of the luminaire of FIG. 18;

FIG. 20 is a schematic circuit diagram of an LED driver circuit in accordance with an embodiment of the invention;

FIG. 21 is an exploded assembly isometric view of an A19 luminaire in accordance with an embodiment of the invention;

FIG. 22 is an exploded assembly isometric view of a G25 luminaire in accordance with an embodiment of the invention;

FIG. 23 is an exploded assembly isometric view of an R20 luminaire in accordance with an embodiment of the invention;

FIG. 24 is an exploded assembly isometric view of an R30 luminaire in accordance with an embodiment of the invention; and

FIG. 25 is an exploded assembly isometric view of an R38 luminaire in accordance with an embodiment of the invention.

The detailed description explains embodiments of the invention, together with advantages and features, by way of example with reference to the drawings.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

An embodiment of the invention, as shown and described by the various figures and accompanying text, provides a luminaire with light emitting diodes (LEDs) that is suitable for replacing a standard A19 light bulb, such as that defined by ANSI C78.20-2003 for example, equipped with a threaded connector, sized and shaped as an Edison E26 medium base defined by ANSI C81.61-2007 or IEC standard 60061-1 (7004-21A-2) for example, suitable to be received in a standard electric light socket, where the driver circuit for the luminaire is self-contained within the A19 profile and is dimmable.

While an embodiment of the invention described herein depicts an A19 light bulb, it be appreciated that the scope of the invention is not so limited, and also encompasses other types and profiles of light bulbs, such as G25, R20, R30 and R38, for example.

While an embodiment described herein depicts a certain topology of circuit components for driving the LEDs, it should be appreciated that the disclosed invention also encompasses other circuit topologies falling within the scope of the claims. It should also be appreciated that while embodiments disclosed herein describe the claimed invention in terms of an A19 light bulb envelope or an Edison E26 medium base, the claimed invention is not necessarily so limited.

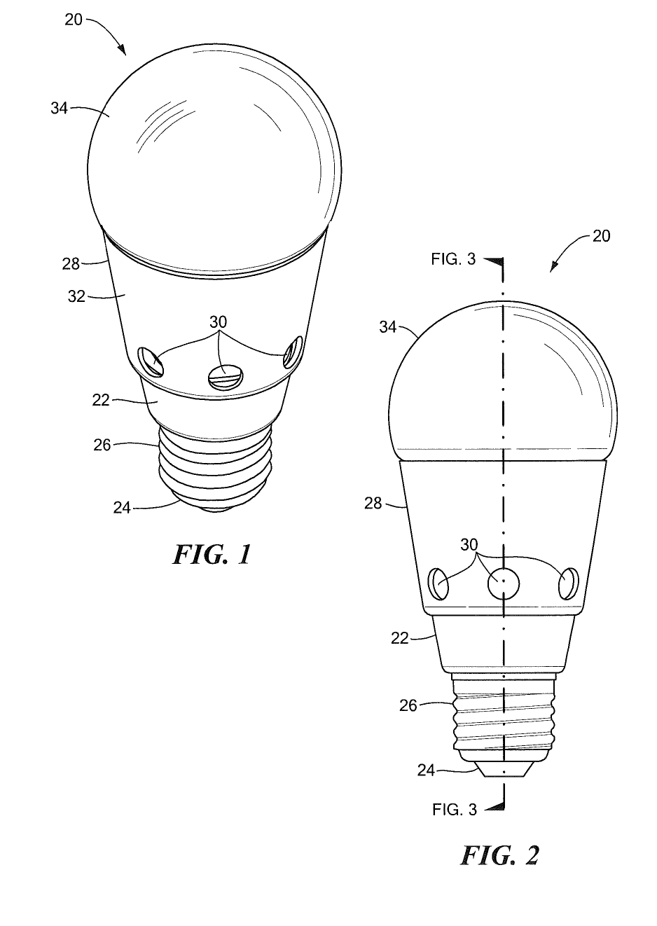

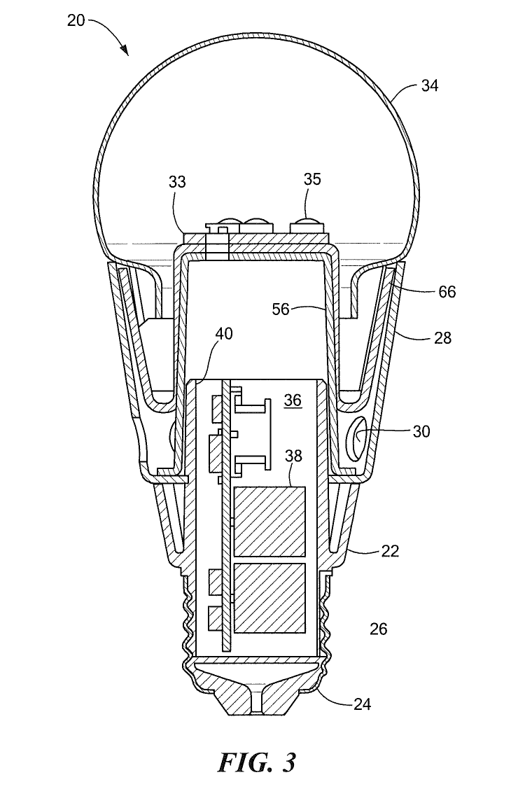

FIGS. 1-4 depict an example LED luminaire 20 having an intermediate member 22 with an Edison type base 24 (alternatively herein referred to as an electrical connector) with appropriately sized threads 26 sized and shaped to be received in a standard electric light socket. In an embodiment, base 24 is an Edison E26 medium base. Coupled to the intermediate member 22 is a heat sink 28 that includes a plurality of openings 30 along a sidewall 32. Heat sink 28 is in thermal communication with an LED light source 31 (discussed in more detail below) to allow dissipation of thermal energy from the luminaire 20. The light source 31 includes a circuit board 33 having a plurality of LEDs 35 mounted thereon. In an example embodiment, the LEDs 35 are made from a 1/10 millimeter die, and operate at a lower voltage than other traditional LEDs and may be coupled in series to provide a source of light. When arranged in this manner, advantages may be gained with respect to increased efficiency of the LED driver circuit 38. In an example embodiment, the light source 31 is a 3.3-volt system instead of the 13 volts that would be required for a traditional LED luminaire.

It should be appreciated that other advantages may be gained by improving the efficiency of the lighting source 31 and the driver circuit 38. These advantages include an increased amount of luminosity for the same amount of thermal energy generated by the LEDs 35. The greater efficiency also allows for a smaller driver circuit 38. These advantages combine to provide a luminaire 20 that fits within the size envelope of an A19 bulb while having an equivalent luminosity performance as a 60-watt incandescent bulb.

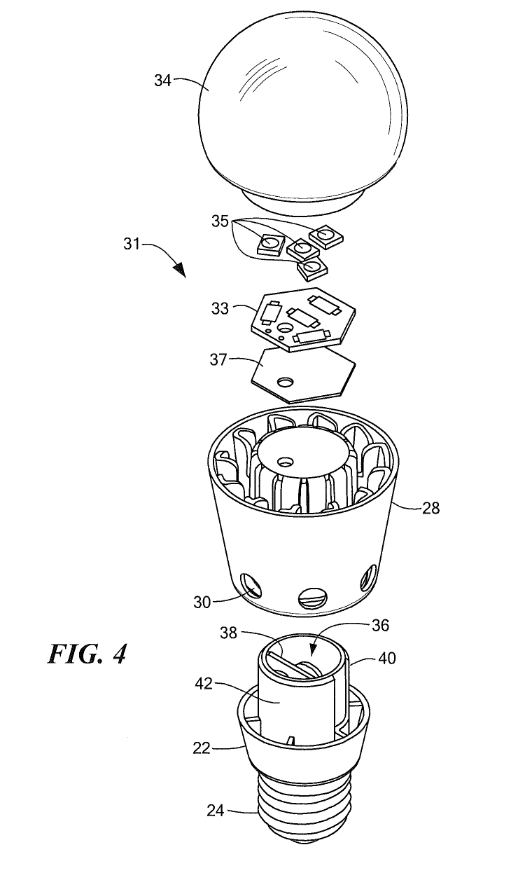

A pad 37 (FIG. 4), such as the GAP PAD VO manufactured by the Bergquist Company for example, may be disposed between the circuit board 33 and the heat sink 28 to provide a thermally conductive and electrically/voltaically insulative interface material. An optic 34 is coupled to an end of the heat sink 28 opposite the intermediate member 22. In one embodiment, the optic 34 is made from a polycarbonate material. In some embodiments, the optic 34 may also provide beam shaping through the use of crystalline material, such as borosilicate for example (discussed in more detail below).

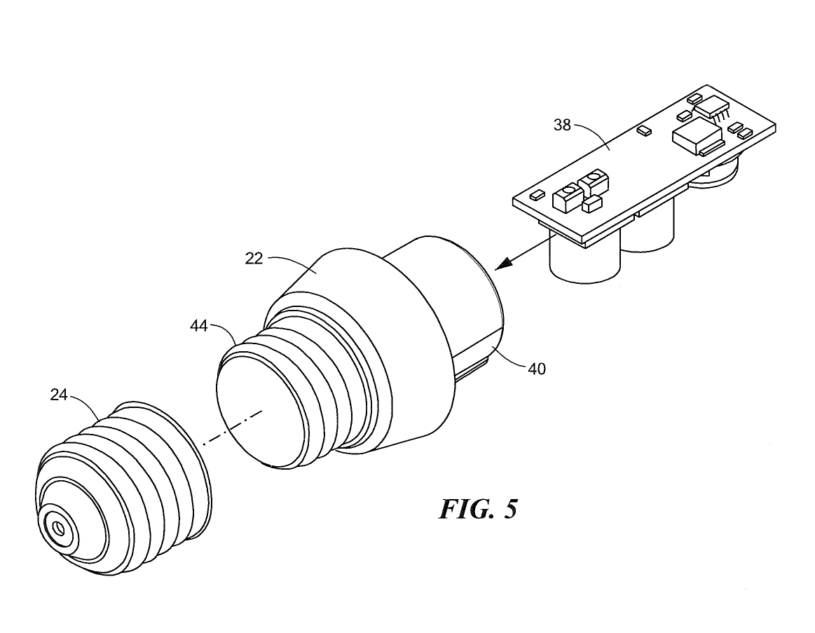

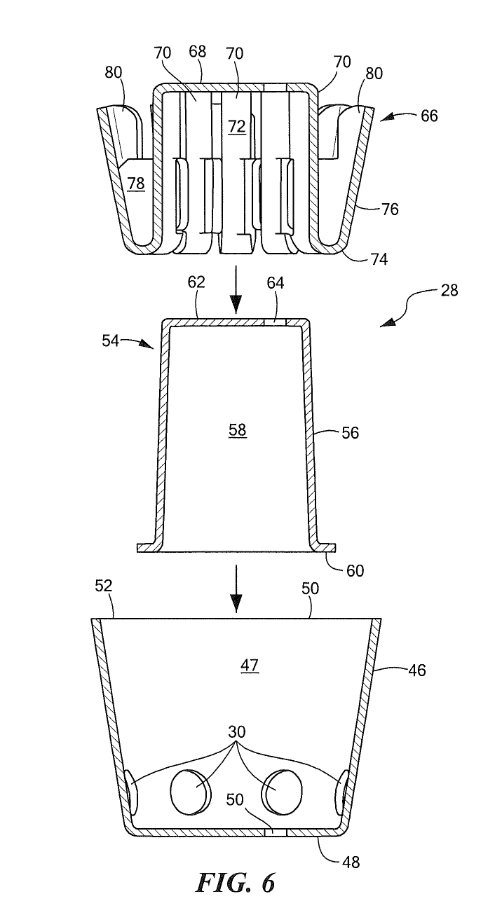

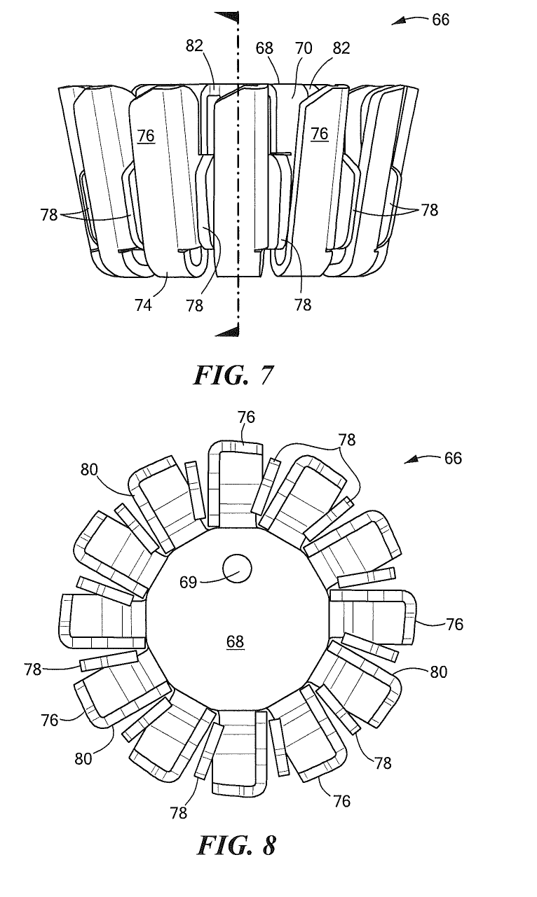

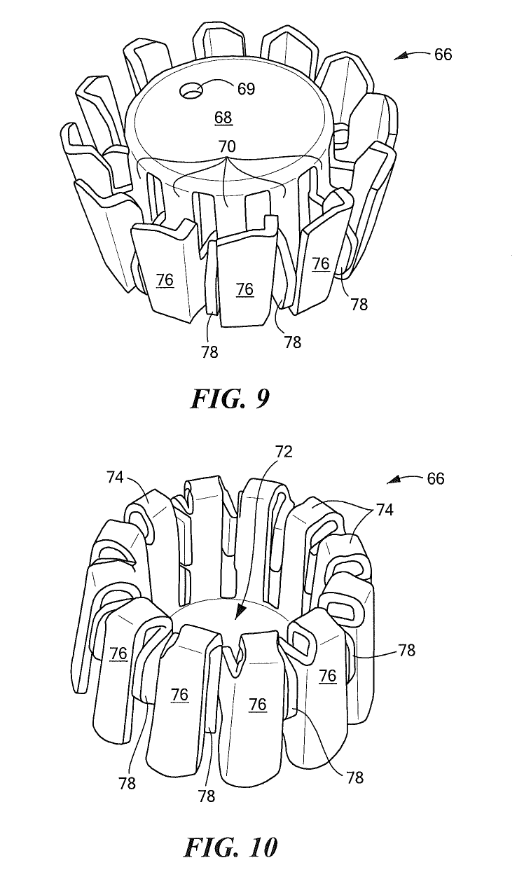

In the embodiment illustrated in FIGS. 1-10, the intermediate member 22 includes a projection 40 having generally hollow portion 36. The driver circuit 38 is arranged within the hollow portion 36 and is electrically coupled to the electrical connector 24. The projection 40 extends into the heat sink 28 and may include one or more features, such as surface 42 for example, that are sized to fit with a corresponding receiving feature (not shown) on the heat sink 28. This allows the intermediate member 22 and the heat sink 28 to be repeatably and reliably assembled relative to each other in a desired orientation. The intermediate member 22 may include a threaded portion 44 (FIG. 5) that is sized to engage with threads 26 of the electrical connector 24. In this embodiment, the heat sink 28 includes a generally thin walled shell 46 (FIG. 6) having a hollow interior 47 with an end wall 48 on one end. The end wall 48 includes an opening 50 sized to receive the projection 40. The plurality of openings 30 are arranged in the sidewall 32 adjacent the end wall 48. Opposite the end wall 48 is a second end 52 having an opening 51. The openings 30 may also have other shapes, such as oval, elliptical, or egg shaped for example.

A cup member 54 is arranged within the hollow interior 47 of the heat sink 28. The cup member 54 includes a tapered sidewall 56 defining a hollow interior area 58. A flange 60 is arranged on one end of the sidewall 56 and a wall 62 is arranged on an opposite end of the sidewall 56. In the example embodiment, the wall 62 substantially encloses one end of the interior area 58. A hole 64 is sized to allow passage of conductors from the circuit driver 38. When assembled, the flange 60 contacts the end wall 48 of the shell 46.

A third component of the heat sink 28 is a fin portion 66 (FIGS. 6-10). In the example embodiment, the fin portion 66 includes a wall 68 with a plurality of arms 70 extending therefrom. A hole 69 is arranged in the wall 68 and is sized and positioned to substantially align with the hole 64 in cup member 54. The plurality of arms 70 define an interior area 72 that is sized to allow the fin portion 66 to be disposed about and in contact with the cup member 54. Each of the plurality of arms 70 extend to a bend 74 and then extend in substantially the opposite direction to form a second portion 76. The second portion tapers on an angle that is sized to allow the fin portion 66 to be disposed within the interior area 47 of shell 46. In one embodiment, the plurality of arms 70 are arranged such that the bend 74 is positioned above the openings 30 when assembled in the shell 46 such that the bend 74 is not visible through the openings 30 when viewed from the side. It should be appreciated that the plurality of arms 70 may also be arranged to be positioned in between the openings 30.

In some embodiments, each of the plurality of arms 70 includes a finger 78 extending substantially radially outward from a respective arm 70. Each second portion 76 of the plurality of arms 70 may also include a projection 80. The projection 80 extends substantially radially inward and into a gap 82 between each of the plurality of arms 70.

In the example embodiment, the shell 46, the cup member 54 and the fin portion 66 are made from a metal with good thermal conduction properties such as 5052 aluminum for example. A progressive die stamping process may be used to make the fin portion 66. In some embodiments, surface treatments including clear anodize or copper plating may be applied to the fin portion 66 to increase thermal conduction performance.

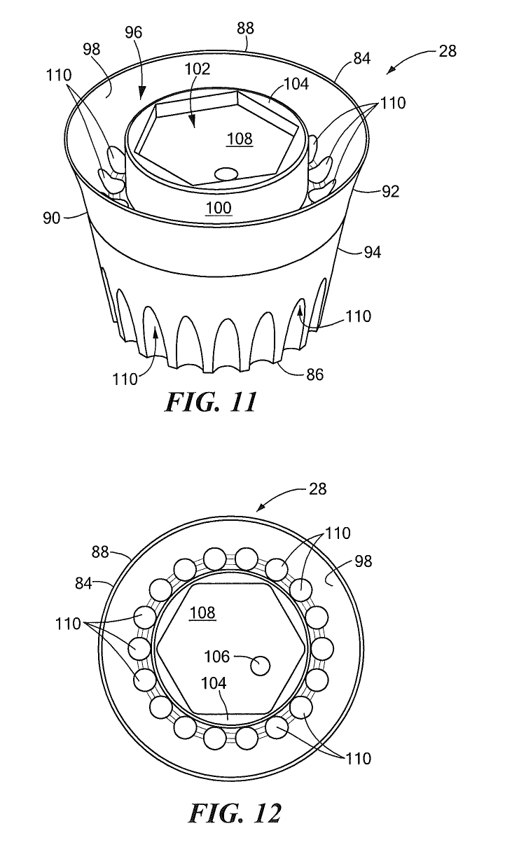

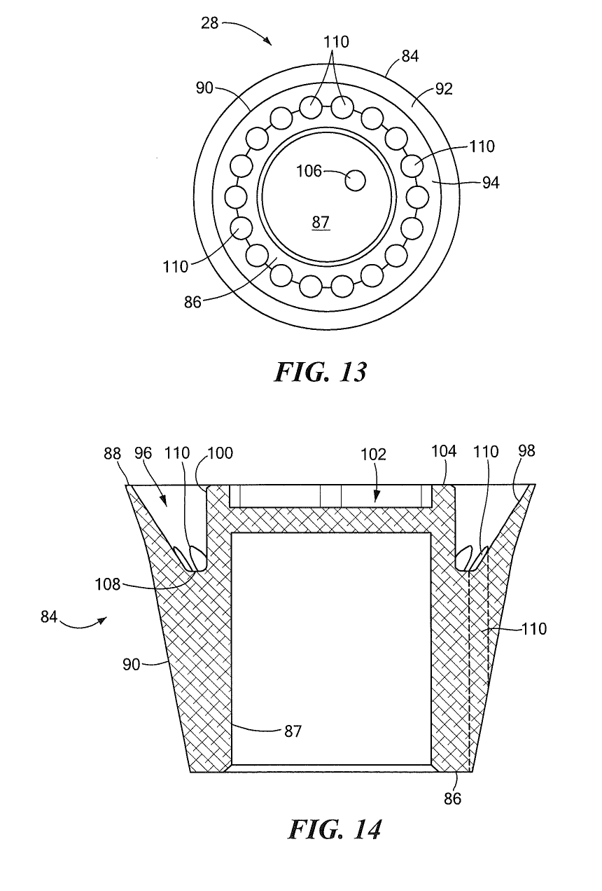

Another embodiment of the heat sink 28 is depicted in FIGS. 11-14 and is formed from a single, monolithic member 84 (herein also referred to as a “heat sink”) manufactured by a process such as forging for example. The heat sink 84 includes a first end 86 and a second end 88 with an outer surface 90 therebetween. In one embodiment, the outer surface 90 includes a curved portion 92 and a frustoconical tapered portion 94. In other embodiments, the outer surface 90 may be a contiguous frustoconical taper or a contiguous curved surface.

The first end 86 includes a substantially cylindrical opening 87 (FIG. 14) that extends towards the second end 88. The opening 87 is sized to receive the projection 40 of intermediate member 22. In some embodiments, the opening 87 may be shaped to accept the surface 42 to allow the intermediate member 22 and heat sink 28 to be assembled in the desired orientation.

The second end 88 includes a recess 96 having a conical surface 98 and a central cylindrical projection 100. An intermediate surface 108 (FIG. 11) is disposed between the conical surface 98 and the central cylindrical projection 100. It should be appreciated that while the intermediate surface 108 is illustrated as being substantially flat, other shapes are contemplated, such as a curved surface or a fillet for example. A recess 102 is formed in the end surface 104 of the central cylindrical projection 100. The recess 102 is sized and shaped to receive the pad 37 and circuit board 33. A hole 106 (FIGS. 11-13) extends through the heat sink 28 from the bottom surface 108 of the recess 102 through to the underside of bottom surface 108. As discussed above with respect to holes 64, 69, the hole 106 provides a passage to allow conductors from the circuit driver 38 to be connected to the circuit board 33. It should be appreciated that while recess 102 is illustrated as being substantially hexagonal, other shaped recesses, such as circular for example, are contemplated.

A plurality of holes 110 is formed in the recess 96 and is equally spaced about the recess 96. In the example embodiment, the holes 110 extend through the heat sink 84 exiting at, adjacent, or proximate, the first end 86. Due to the taper and/or curve of outer surface 90, the holes 110 intersect both the outer surface 90 and the first end 86. In some embodiments, the holes 110 are formed on a diameter such that the holes 110 may only intersect the outer surface 90. In still other embodiments, the holes 110 are sized and positioned to only intersect the first end 86 as shown in FIG. 11. In the example embodiment, there are eighteen holes 110 having a diameter of 4.76 millimeters (0.188 inches) arranged on a 37.50-millimeter (1.476 inch) bolt circle diameter.

In the example embodiment, the heat sink 84 is made from 6061 or 6063 aluminum through a forging process for example. The heat sink 84 may include surface treatments, including but not limited to: anodized (clear or colored); powder coated; ceramic; painted; or plated, for example.

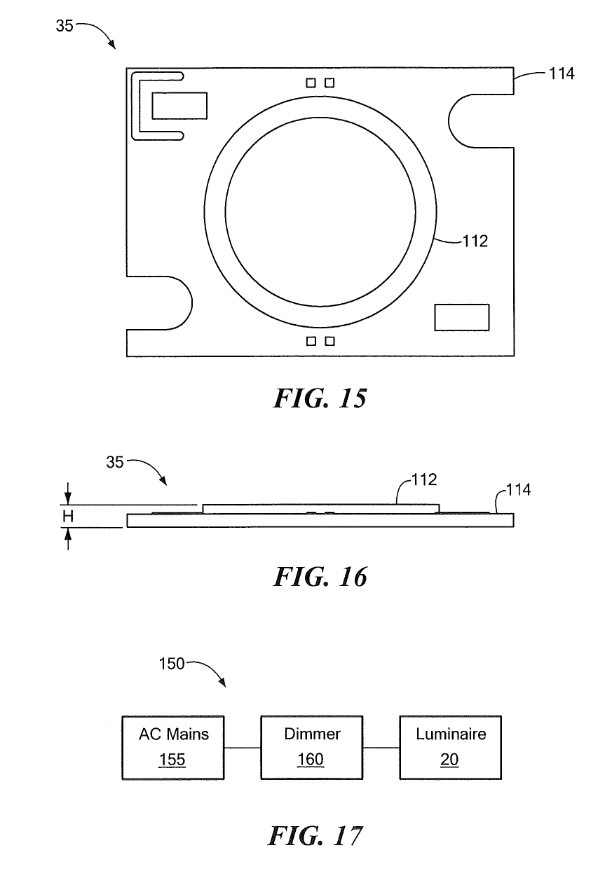

FIGS. 15-16 illustrate an LED 35 having a flat surface emitter LED 112 with a back plane 114. In the example embodiment, the flat surface emitter LED 112 is manufactured using a 1/10 millimeter die, which allows the flat surface emitter LED 112 to have a smaller profile height than a traditional LED. In the example embodiment, the flat surface emitter LED 112 has a height “H” of 1.4 millimeters (0.552 inches) above the surface of the circuit board 33. In one embodiment, luminaire 20 includes five flat surface emitter LEDs 112 to produce a luminosity equivalent to a 60-watt incandescent light bulb. Advantages may be gained by combining a frosted optic 34 with a light source having flat surface emitter LEDs 112 in that the luminaire 20 will create an appearance of a filament that would be found in an incandescent bulb. This may create a more pleasing experience to an end user who is use to traditional incandescent light bulbs.

During operation, the luminaire 20 is coupled to a lighting system 150, depicted in FIG. 17, such that the electrical contact 24 is disposed to receive electrical current from an AC mains 155 power supply via a switch or dimmer switch 160. The electrical current flows through the electrical contact 24 into the driver circuit 38, which adapts the input electrical current to have characteristics desirable for operating the LEDs 35. In an example embodiment, the driver circuit 38 includes circuitry for accommodating a dimmable lighting system (discussed in more detail below). In some conventional lighting systems, a dimmer switch may be used to lower the luminosity of the light bulbs. This is usually accomplished by chopping the AC current or in more elaborate systems by stepping down the voltage. Unlike an incandescent light bulb, which can tolerate (to a degree) sudden and large changes in the electrical voltage, the LED device performance will be less than desirable. In this embodiment, the driver circuit 38 includes circuitry for smoothing out the input electrical voltage and current to allow the LEDs 35 to operate without interruption of electrical power at lower luminosity levels.

The driver circuit 38 outputs a signal, analogous to a DC electrical current, to the circuit board 33. The circuit board 33 distributes the signal to the LEDs 35. In response to this signal, the LEDs generate photons of light that are directed into the optic 34, which diffuses the photons to illuminate the desired area.

As the LEDs 35 generate light, heat is generally generated on the backplane of the LEDs 35. In an embodiment, this thermal energy is transferred from the LEDs 35 into the circuit board 33. The pad 37 conducts the thermal energy from the circuit board 33 and into the heat sink 28, 84. In the embodiments having heat sink 28, the thermal energy is conducted through the plurality of arms 70 and into the shell 46. The shell 46 in turn dissipates the heat through natural convection to the surrounding environment. In applications where ventilation is available, the heat transfer from the heat sink 28 may be increased through convection via openings 30.

Similarly, in embodiments having heat sink 84, the thermal energy from the pad 37 is conducted into the heat sink 84 by surface 108. The heat is conducted to the outer surface 90 and dissipated into the surrounding environment. Where ventilation is available, additional heat may be transferred from the heat sink 84 by natural convection via holes 110.

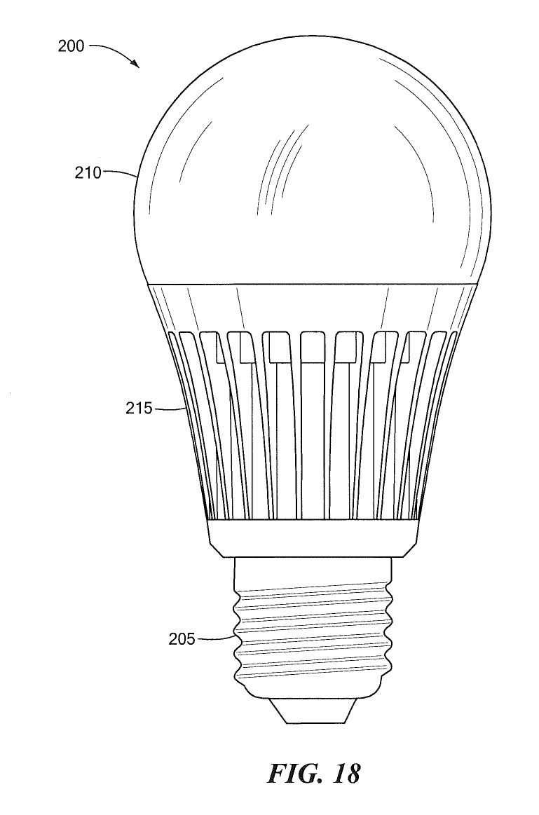

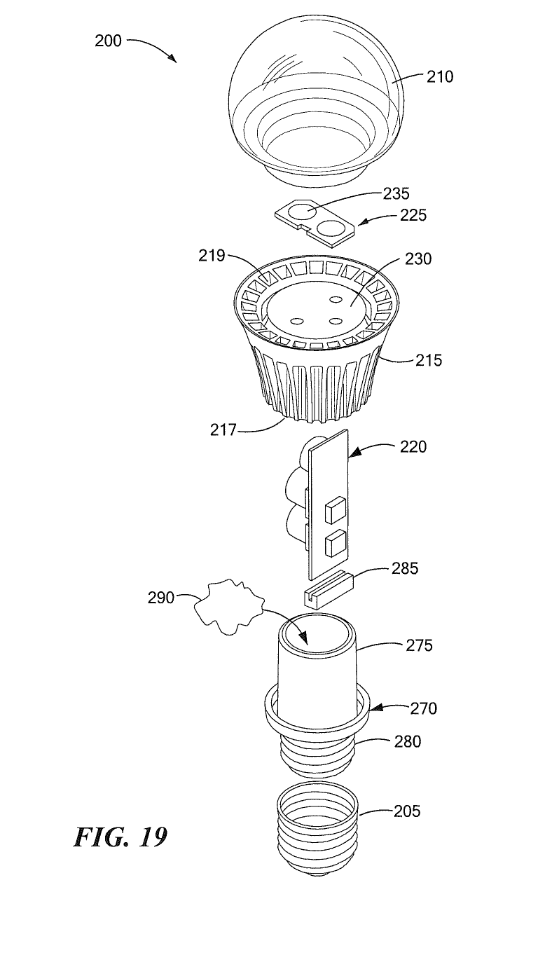

Referring now to FIGS. 18-19 an alternative to luminaire 20 is depicted as luminaire 200, which also includes an Edison type electrical base 205 (herein also referred to as the “base”), an optic 210, and a heat sink 215 disposed between the base 205 and the optic 210.

FIG. 19 is an example exploded assembly view of the luminaire 200, showing an LED driver circuit 220 (also herein referred to as the “driver circuit”) being arranged so as to be at least partially disposed within the heat sink 215 from an underside of the heat sink 215, and being arranged so as to be in electrical communication with the base 205 (specifics of the electrical circuitry of LED driver circuit 220 will be discussed in more detail below). An LED assembly 225 is disposed in thermal communication with a surface 230 of the heat sink 215, and is in electrical communication with the driver circuit 220. The LED assembly 225 includes at least one LED 235, and more typically includes a plurality of LEDs. An intermediate member 270 receives the driver circuit 220 within an integrally formed hollow projection 275, and receives the base 205 via an integrally formed threaded portion 280. In an embodiment, the driver circuit 220 and the hollow projection 275 are at least partially disposed within the heat sink 215 from an underside of the heat sink 215. In an embodiment, heat sink 215 is a unitary form made by casting or forging aluminum with appropriately shaped surface fins 217 and vents 219 for heat transfer, as discussed above. Other heat sinks suitable for the purposes disclosed herein may also be applicable and are considered within the scope of the invention disclosed herein.

In an embodiment, a support member 285 is disposed underneath driver circuit 220 to centrally position driver circuit 220 inside the intermediate member 270 prior to applying a curable encapsulant 290 into the hollow projection 275 of intermediate member 270, thereby fixing the driver circuit 220 relative to the hollow projection 275. By centrally positioning the driver circuit 220 inside intermediate member 270 and then applying an encapsulant 290, thermal management and vibration absorption of the driver circuit 220 is achieved. In an embodiment, support member 285 is a rigid foam, and encapsulant 290 is Dow Corning encapsulant material 3-6551 available from Dow Corning, but each may be made using any other material suitable for the purposes disclosed herein. While support member 285 is illustrated in FIG. 19 being a U-shaped extruded or molded form, it will be appreciated that the invention encompasses any form suitable for the purposes disclosed herein, such as two planar panels each disposed on opposing sides of circuit driver 220 inside the hollow projection 275 for example.

As can be seen by comparing FIGS. 18-19 with FIGS. 1-5, base 205 compares with base 24, optic 210 compares with optic 34, heat sink 215 compares with heat sink 28, intermediate member 270 compares with intermediate member 22, circuit driver 220 compares with circuit driver 38, and LEDs 235 compare with LEDs 35. As such, the various alternative embodiments disclosed herein are considered interchangeable variations of a common design.

From the foregoing, it will be appreciated that the Edison base 205, optic 210 and heat sink 215 of luminaire 200, collectively have a profile so configured and dimensioned as to be interchangeable with a standard A19 light bulb, and the LED driver circuit 220 and the LED assembly 225 are so configured and dimensioned as to be disposed completely within the A19 profile.

In an embodiment, the optic 34, 210 illustrated in FIGS. 1-4 and 18-19 is made from a molded polycarbonate or glass material. Alternatively, the optic 34, 210 may include crystalline particulate material, such as borosilicate for example, that is molded into the material. In some embodiments, the optic 34, 210 may also have a variable density, such as by forming the optic 34, 210 in a multistage molding process. The crystalline particulate material and/or variable density increases the amount of diffusion and allows for beam shaping of the emitted light. In some embodiments, the optic 34, 210 is frosted to have a substantially white opaque appearance.

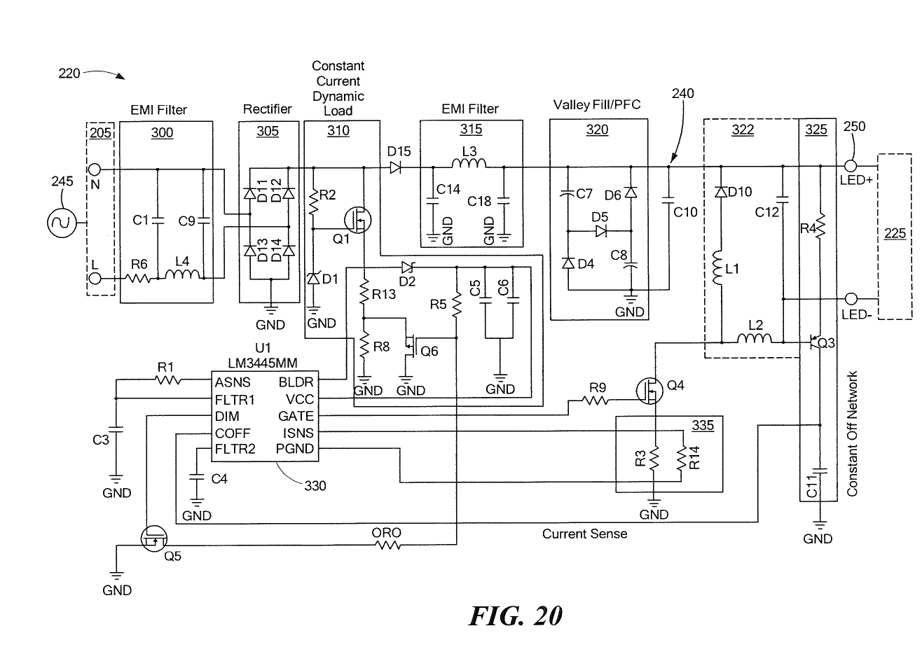

As discussed above with reference to FIG. 17, an embodiment of the invention may employ a dimmer 160. In an embodiment, dimmer 160 is a TRIAC (triode for alternating current) dimmer, which is a standard style of dimmer presently used for incandescent or halogen based light lamps. With such incandescent or halogen lamps, the lamp appears to be a resistive load to the TRIAC dimmer. However, when used with LED light lamps, the LED lamp does not look like a resistive load to the TRIAC dimmer, which requires a minimum threshold current flow when the line voltage is held low (such as in dimming mode) to enable proper firing of the TRIAC. With incandescent or halogen lamps, the resistive load provides the required minimum current flow. With an LED lamp, holding current circuitry 255 (FIG. 20) provides for the minimum threshold current flow, which will be discussed in more detail below.

Referring now to FIG. 20, an example schematic of the driver circuit 220 includes circuitry 240 that converts an AC signal 245 at input nodes “N” and “L” in electrical connection with the base 205, to a DC signal 250 at output nodes “LED+” and “LED−”, and provides the DC signal 250 to the LED assembly 225 and LEDs 235.

With reference to FIG. 20, an example topology of circuitry 240 will first be described generally, and then more specifically.

Input nodes “N” and “L” provide input to circuitry 240, which is optionally first connected to an EMI (electromagnetic interference) filter 300. While it may not be necessary to employ EMI filter 300 as a pre-filter stage, such use does serve to filter switching noise so as to remove electrical interference before it gets conducted onto the grid of circuitry 240.

Downstream of EMI filter 300 is rectifier circuitry 305 that rectifies the AC signal received at input nodes “N” and “L”.

Downstream of rectifier circuitry 305 is holding current circuitry 310 that produces a holding current for TRIAC dimmer 160 disposed upstream of the base 205 of luminaire 200, between luminaire 200 and AC mains supply 155 (see FIG. 17), in response to a current to the LED assembly 225 being reduced by the dimmer 160 for light dimming purposes.

Downstream of holding current circuitry 310 is a second stage EMI filter 315 for further removal of electrical interference.

Downstream of EMI filter 315 is valley fill power factor correction circuitry 320 that performs power factor correction and reduces supply voltage ripple.

Downstream of correction circuitry 320 is LED output circuitry 322 that provides the DC signal to the LED assembly 225.

Downstream of the LED output circuitry 322 is constant off circuitry 325 that reduces electrical noise at the LED assembly 225 and spreads the noise spectrum to reduce noise amplitude.

A microprocessor-based controller 330 is disposed in signal communication with the holding current circuitry 310 and the LED output circuitry 322, and is responsive to a voltage at the holding current circuitry 310 for producing a control signal to the holding current circuitry 310 for producing the holding current necessary for proper firing of TRIAC dimmer 160. In an embodiment, controller 330 is LM3445 available from National Semiconductor Corporation.

Current sense circuitry 335 is disposed in signal communication with the controller 330 and the LED output circuitry 322, and determines the LED current sense by measuring the voltage sensed across the resistors connected to the ISNS and PGND pins of controller 330.

Regulator (R2, D1 and Q1) of holding current circuitry 310 translates the rectified line voltage to a level at which it can be sensed by the BLDR pin of controller 330. Diode-capacitor network (D2, C5 and C6) of holding current circuitry 310 maintains the voltage on the VCC pin of controller 330 while the voltage on the BLDR pin goes low, thereby providing supply voltage to operate controller 330. Resistor-transistor network (R8, R13 and Q6) of holding current circuitry 310 is connected between the source of Q1 and ground (GND). As the LED current is reduced during dimming mode, resistors R8 and R13 bleed electrical charge out of any stray capacitance on the BLDR pin of controller 330, which in turn switches on Q6 to cause more current through Q1. Thus, as the LED current reduces, the current through Q1 will compensate to keep a desired holding current for the TRIAC dimmer 160 throughout the AC line cycle.

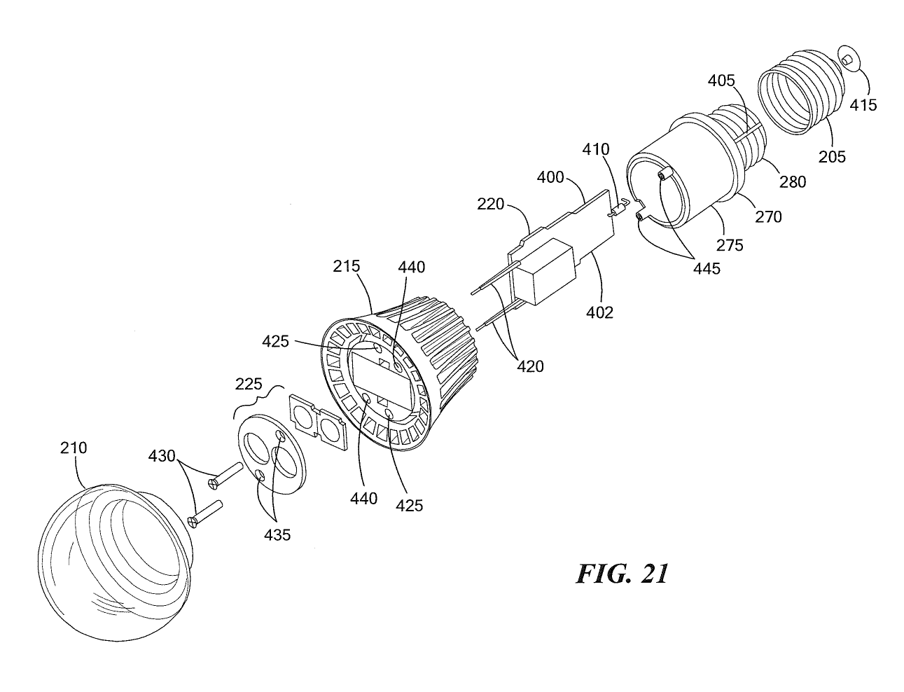

Reference is now made to FIG. 21, which depicts in further detail electrical and mechanical connections associated with the various parts and subassemblies of luminaire 200. In an embodiment, the edge 400 of the circuit board 402 of driver circuit 220 is assembled into the grooves 405 (only one groove is depicted, with the other groove being diametrically opposed to the visible groove) of intermediate member 270, which in an embodiment is molded from an electrically insulative material, such as thermoset or heat resistant thermoplastic for example, thereby enabling a first electrical connection to be made between the base 205 and the edge 400 of circuit board 402 once the base 205 is screwed onto the threaded portion 280 of the intermediate member 270, the edge 400 having an electrical trace or wire disposed thereat. While not specifically depicted, a bus wire may be wrapped around the edge of the intermediate member 270 and positioned along the grooves 405 prior to assembling the base 205 onto the threaded portion 280, and then subsequently soldered, thereby providing a more definite first electrical connection between the base 205 and the electrical trace or wire at edge 400 of circuit board 402.

A second electrical connection at the Edison base 205 is established by passing the electrical wire 410 connected to circuit driver 220 through a central hole (hidden from view in the perspective of FIG. 21) in the bottom of the intermediate member 270 and the base 205, and attaching the wire 410 to the base 205 via a solder ball 415. As such, and in the assembled state, Edison base 205 has two electrical connections with driver circuit 220.

The driver circuit 220, heat sink 215, and LED assembly 225 are assembled together by passing the electrical pins 420 (having insulated sleeves disposed thereon) of the driver circuit 220 through holes 425 in the heat sink 215, and making an electrical connection to the LEDs 235 of LED assembly 225 in a manner known in the art.

Screws 430 pass through holes 435 in the LED assembly 225 and through holes 440 in the heat sink 215, and are threaded into posts 445 of intermediate member 270, which in an embodiment are integrally molded with the hollow projection 275, thereby securely fastening the sandwiched parts/subassemblies of luminaire 200 together.

Optic 210 is attached to the heat sink 215 in any manner suitable for the purpose, such as by applying a bead of epoxy therebetween for example.

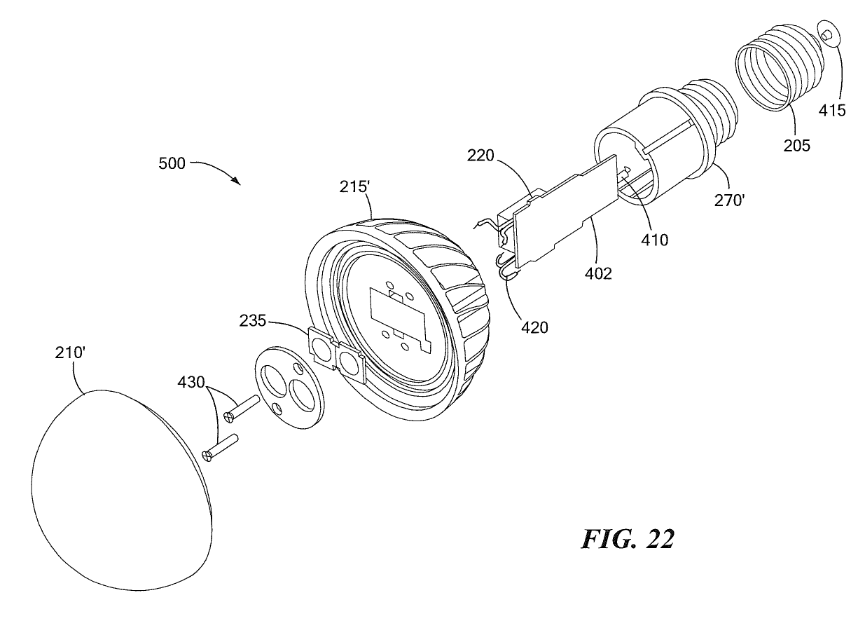

Reference is now made to FIGS. 22-25, which depict alternative luminaire configurations suitable for use in accordance with an embodiment of the invention, where like elements are numbered alike, and where similar elements are distinguished using one or more “prime” symbols.

FIG. 22 depicts a G25 luminaire 500 having a profile so configured and dimensioned as to be interchangeable with a standard G25 light bulb.

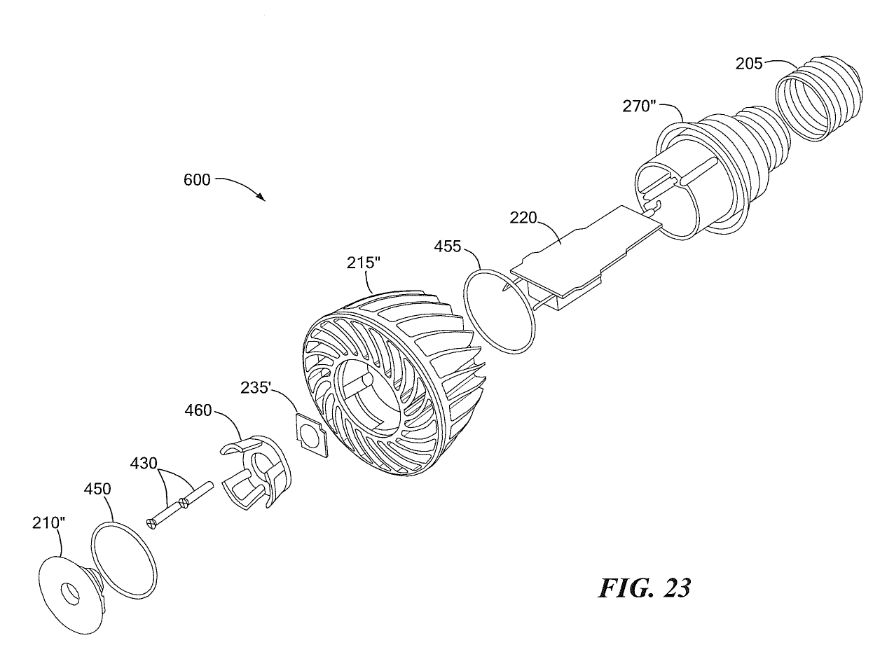

FIG. 23 depicts a R20 luminaire 600 having a profile so configured and dimensioned as to be interchangeable with a standard R20 light bulb.

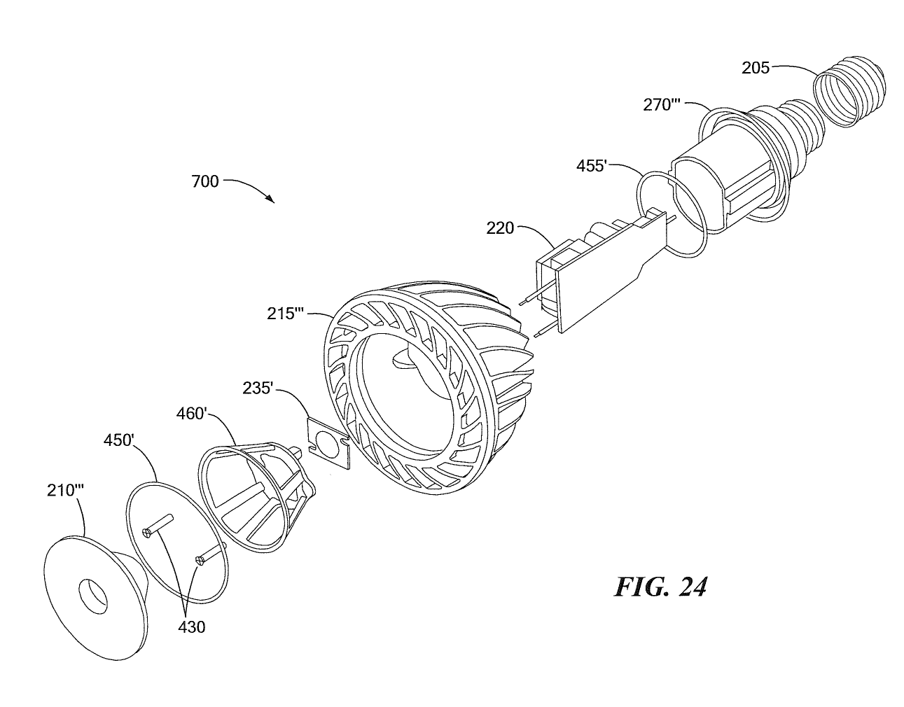

FIG. 24 depicts a R30 luminaire 700 having a profile so configured and dimensioned as to be interchangeable with a standard R30 light bulb.

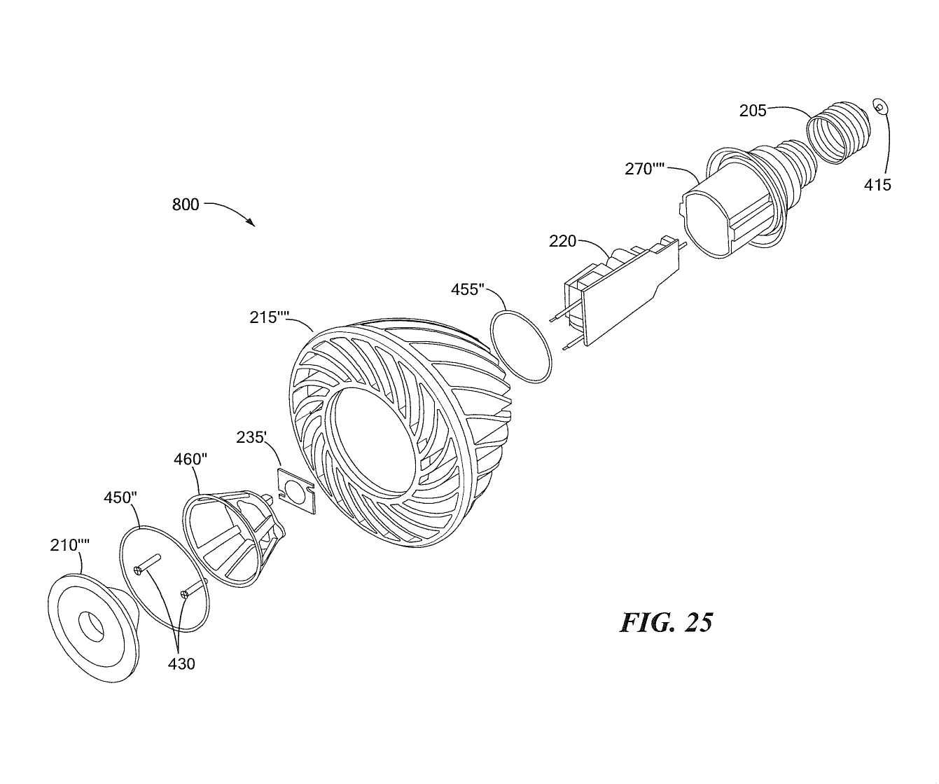

FIG. 25 depicts a R38 luminaire 800 having a profile so configured and dimensioned as to be interchangeable with a standard R38 light bulb.

Each luminaire 500, 600, 700 and 800 has an Edison base 205, an intermediate member 270, a heat sink 215 (designated by respective prime symbols), an optic 210 (designated by respective prime symbols), an LED driver circuit 220, and LEDs 235 (designated by respective prime symbols), collectively so configured and dimensioned as to be disposed completely within each respective G25, R20, R30 and R38 profile. More particularly, each luminaire 200, 500, 600, 700 and 800, includes a driver circuit 220 so configured and dimensioned as to be disposed completely within each respective A19, G25, R20, R30 and R38 profile.

With reference to FIGS. 23-25, embodiments of R20 luminaire 600, R30 luminaire 700, and R38 luminaire 800, each include an O-ring 450 for sealing respective optic 210 to respective heat sink 215, an O-ring 455 for sealing respective heat sink 215 to respective intermediate member 270, and a lens holder 460 for retaining respective optic 210 in association with respective heat sink 215.

As disclosed, some embodiments of the invention may include some of the following advantages: LED luminaire usable as a direct replacement for incandescent light bulbs in existing lighting systems; dimmable LED luminaire; LED luminaire having lower energy usage, increased heat diffusion, and/or increased luminosity with respect to an incandescent bulb having a similar lumen rating or with respect to a prior art LED luminaire having a similar operational power rating; and, an LED luminaire that creates a light output appearance of an incandescent bulb.

The particular and innovative arrangement of components according to the invention therefore affords numerous not insignificant technical advantages in addition to an entirely novel and attractive visual appearance.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A luminaire, comprising:
an Edison type electrical base, an optic, and a heat sink disposed between the base and the optic;
an LED driver circuit disposed at least partially within the heat sink, and disposed in electrical communication with the base; and
an LED assembly disposed in thermal communication with a surface of the heat sink, and in electrical communication with the driver circuit, the LED assembly comprising an LED;
the driver circuit comprising circuitry that converts an AC signal at the base to a DC signal and provides the DC signal to the LED assembly, the circuitry comprising holding current circuitry that produces a holding current for an electrical dimmer disposed upstream of the base in response to a current to the LED assembly being reduced for light dimming purposes.

2. The luminaire of claim 1, wherein the circuitry of the driver circuit further comprises:
rectifier circuitry, disposed upstream of the holding current circuitry, that rectifies the AC signal;
correction circuitry, disposed downstream of the holding current circuitry, that performs power factor correction and supply voltage correction;
LED output circuitry, disposed downstream of the correction circuitry, that provides the DC signal to the LED assembly; and
a controller disposed in signal communication with the holding current circuitry and the LED output circuitry, wherein the controller comprises a microprocessor responsive to a voltage at the holding current circuitry for producing a control signal to the holding current circuitry for producing the holding current.

3. The luminaire of claim 2, wherein the circuitry of the driver circuit further comprises:
constant off circuitry, disposed downstream of the correction circuitry, that reduces electrical noise at the LED.

4. The luminaire of claim 1, wherein the circuitry of the driver circuit further comprises:
an EMI filter and a rectifier, both disposed upstream of the holding current circuitry, the EMI filter being disposed proximate the base for receiving the AC signal and being adapted and configured for filtering electrical noise ahead of the rectifier.

5. The luminaire of claim 1, further comprising:
a stem portion disposed between the Edison type electrical base and the heat sink, the driver circuit being disposed at least partially within the stem portion; and
an encapsulant disposed fixing the driver circuit and the stem portion.

6. The luminaire of claim 5, further comprising:
a support member disposed between the driver circuit and the stem portion, the encapsulant being disposed fixing the support member to the driver circuit, and to the stem portion.

7. The luminaire of claim 1, wherein the Edison type electrical base, the optic, and the heat sink, collectively have a profile so configured and dimensioned as to be interchangeable with a standard A19 light bulb, and the LED driver circuit and the LED assembly are so configured and dimensioned as to be disposed completely within the A19 profile.

8. A luminaire, comprising:
an Edison type electrical base, an optic, and a heat sink disposed between the base and the optic, wherein the base, the optic, and the heat sink, collectively have a profile so configured and dimensioned as to be interchangeable with at least one of a standard A19 light bulb, a standard G25 light bulb, a standard R20 light bulb, a standard R30 light bulb, and a standard R38 light bulb;
an LED driver circuit disposed in electrical communication with the base; and
an LED assembly disposed in thermal communication with a surface of the heat sink, and in electrical communication with the driver circuit, the LED assembly comprising an LED;
the driver circuit comprising circuitry that converts an AC signal at the base to a DC signal and provides the DC signal to the LED assembly;
wherein the LED driver circuit and the LED assembly are so configured and dimensioned as to be disposed completely within the respective A19, G25, R20, R30 or R38 profile.

9. A driver circuit for an LED light source connectable to an electrical dimmer disposed upstream of the light source, the driver circuit comprising:
holding current circuitry that produces a holding current for the electrical dimmer in response to a current to the LED light source being reduced for light dimming purposes;
rectifier circuitry, disposed upstream of the holding current circuitry, that rectifies an AC signal into a DC signal;
correction circuitry, disposed downstream of the holding current circuitry, that performs power factor correction and supply voltage correction;
LED output circuitry, disposed downstream of the correction circuitry, that provides the DC signal to the LED light source; and
a controller disposed in signal communication with the holding current circuitry and the LED output circuitry, wherein the controller comprises a microprocessor responsive to a voltage at the holding current circuitry for producing a control signal to the holding current circuitry for producing the holding current.

10. The driver circuit of claim 9, further comprising:
constant off circuitry, disposed downstream of the correction circuitry, that reduces electrical noise at the LED light source.

11. The driver circuit of claim 9, further comprising:
an EMI filter and a rectifier, both disposed upstream of the holding current circuitry, the EMI filter being disposed for receiving the AC signal and being adapted and configured for filtering electrical noise ahead of the rectifier.
